(19) United States
(12) Patent Application Publication
(10) Pub. No.: US 2018/0046964 A1
(43) Pub. Date: Feb. 15, 2018

(54) SYSTEMS, DEVICES, AND METHODS OF OPTIMIZING TRUCKING SUPPLY CHAIN LOGISTICS

(71) Applicants: Michael C Leoni, Ann Arbor, MI (US); John Leoni, Ann Arbor, MI (US); Constantine Korolov, Royal Oak, MI (US)

(72) Inventors: Michael C Leoni, Ann Arbor, MI (US); John Leoni, Ann Arbor, MI (US); Constantine Korolov, Royal Oak, MI (US)

(21) Appl. No.: 15/676,987

(22) Filed: Aug. 14, 2017

Related U.S. Application Data
(60) Provisional application No. 62/374,517, filed on Aug. 12, 2016.

(51) Int. Cl. G06Q 10/06; G06Q 10/08

(52) U.S. Cl. CPC G06Q 10/06315; G06Q 10/083

(57) ABSTRACT

Disclosed herein is a platform incorporating systems and methods for analyzing and optimizing supply chain logistics. The platform allows stakeholders in a supply chain to access a server through a client application to perform various logistics, optimization, and access control tasks. Logistics management involves centralizing profile information, tracking load deliveries and facilitating stakeholder communication. Optimization involves analyzing load delivery metrics to influence the creation of job status events through the application. Access control involves providing loading site access to a driver to enable off-hours loading or unloading.

### CLAIM OF PRIORITY

This application claims priority to U.S. Provisional Patent Application Ser. No. 62/374,517, filed Aug. 12, 2016, the entire disclosure of which is hereby expressly incorporated by reference herein.

### FIELD OF TECHNOLOGY

This disclosure relates generally to logistics systems and devices and, more particularly, to a system, device and a method of optimizing trucking supply chain logistics.

### BACKGROUND

The trucking industry today is experiencing a significant loss in productivity. This loss is caused in part by drivers simply not being satisfied with their work pay. During the course of a picking up and delivering loads, a driver experiences numerous setbacks, including truck congestion, reduced drive time, and detention time.

Drivers have a limited window of opportunity to load or unload. The typical delivery window is on average from 7 am to 4 pm. This limited window causes drivers to travel at the same times, leading directly to heavier congestion and delayed deliveries. A survey taken in 2014 states that congestion has costed the trucking industry around $49.6 billion. The total amount of hours trucks were delayed causing a loss in productivity was more than 728 million, which equates to 264,500 commercial truck drivers sitting idle for a working year.

Overall drive time has been reduced due to transportation regulations that reduce driver flexibility. Once starting on-duty time, a driver cannot stop his/her clock until 14 hours is complete, including 11 driving hours and 3 on duty hours. This disadvantage prevents drivers from delivering as many loads as they were accustomed to when they were able to more flexibly start and stop their on-duty service time.

Detention time, during which a truck must wait to load or unload, is one of the greatest sources of loss in the industry. The Federal Motor Carrier Safety Administration estimates that detention time costs trucking companies around $3 billion per year and the public around $6.5 billion per year. Drivers are finding themselves wasting several hours of driving time in detention, even when arriving at a delivery location early—only to find that the unloading bay has not yet opened. When a driver arrives late, usually due to traffic conditions, and misses a delivery window, the driver must usually wait until the next day to deliver his/her load before continuing to pick up another load. A recent poll conducted by Owner-Operator Independent Drivers Association shows that drivers could spend as many as 40 hours per week waiting to be loaded or unloaded. It also found that 59% experienced detention time, and about 65% of them reported lost revenue as a result of detention time from either missing an opportunity to secure another load or paying late fees to the shipper.

These setbacks cause losses and frustration for all stakeholders, not just drivers. Trucking companies find themselves unable to retain drivers due to high driver turnover and the ubiquitous nature of setbacks during the course of a delivery.

Furthermore, idle driving time significantly increases CO₂ emissions. To tackle this, the Environmental Protection Agency and the National Highway Traffic Safety Administration have adopted new regulations for medium- and heavy-duty trucks that are expected to cut approximately 1.1 billion tons of carbon pollution, save vehicle owners nearly $170 billion in fuel costs, and reduce oil consumption by up to 82. These new regulations raise the bar set by previous regulations by 25 percent for tractors, delivery trucks, school buses, and other vocational vehicles, and lock in standards for heavy duty pickup trucks and vans to be become 2.5 percent more efficient annually between Model Years 2021 and 2027. One of the goals of these regulations is to incentivize the use of “ . . . holistic technology approaches for further real world improvements . . . .” Holistic approaches suggest technologies beyond vehicle manufacturing.

Current solutions that engage stakeholders to aid in optimizing supply chain logistics do not account for potential diversity in policies between stakeholders. A driver picking up a delivery at one site may often be met with a different set of policies at the next site (e.g., different loading window, loading supervision required) but may not know until reaching the site or receiving a communication from a dispatcher or site supervisor. For example, a snow storm may cause a site's loading dock access procedure to change, unbeknownst to a driver who may receive instructions too late and access the loading dock in an unsafe manner.

Additionally, current solutions are not streamlined for effectively communicating and accounting for unexpected factors, such as inclement weather, potential detention time, heavy traffic, and other factors that can drastically delay or prevent a delivery. For most of these factors, current solutions provide low resolution data that are uninformative, untimely, or unreliable in the earlier stages of a delivery when such delays can be prevented through effective communication and contingency planning.

Thus, there exists a need for a supply chain optimization system that promotes transparency, reduces operational overhead, and eases collaboration between the various stakeholders.

### SUMMARY

Disclosed is a logistics analysis and optimization software platform. In one aspect, a computer program product comprises instructions executable by one or more computers. When executed by the one or more computers, the instructions cause the one or more computers to receive load details from a job creator. The load details are related to a load to be delivered from a shipper to a receiver by a driver. The shipper is associated with an origin site and the receiver is associated with a destination site. The instructions further cause the one or more computers to receive origin site details and destination site details. Furthermore, the one or more computers receive a pickup confirmation from the driver and a drop-off confirmation from the driver. Then, the one or more computers receive a signed bill of lading from the driver.

In another aspect, a computer program product comprises instructions executable by one or more computers. When executed by the one or more computers, the instructions cause the one or more computers to receive a status event and metrics associated with a load being delivered by a driver. The instructions further cause the one or more computers to compare the metrics to historical data. Historical data comprise metrics and past status events associated with one or more delivered load(s). Furthermore, the instructions further cause the one or more computers to determine a likelihood of a subsequent status event for the load delivery.

Additionally, the instructions may further cause the one or more computers to display The interface and the metrics displayed may be modified to promote the creation of a status event of a type that is statistically more likely to be created according to the determination.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a block diagram that shows an exemplary platform for managing and optimizing trucking logistics.

FIG. 2 is a block diagram that shows an exemplary server of the platform for use in a logistics platform.

FIG. 3 is a block diagram that shows an exemplary client device for use in the logistics platform.

FIG. 4 is a block diagram that shows a number of integrated modules of a logistics application.

FIG. 5 is a block diagram that shows a number of profile databases stored in the server.

FIG. 6 is a block diagram that shows an exemplary access control module for use in the logistics platform.

FIG. 7 is a block diagram illustrating an exemplary access control system.

FIG. 8A is a method diagram illustrating an exemplary job creation process.

FIG. 8B is a method diagram illustrating an exemplary load delivery process.

FIG. 9A is an exemplary personal profile screen of the logistics application.

FIG. 9B is an exemplary site profile screen of the logistics application.

FIG. 9C is an exemplary company profile screen of the logistics application.

FIG. 10 is an exemplary navigation screen of the logistics application.

FIG. 11A is an exemplary load delivery scheduling screen of the logistics application.

FIG. 11B is an exemplary driver selection screen of the logistics application.

FIG. 12A is an exemplary load board screen of the logistics application.

FIG. 12B is an exemplary pending load details screen of the logistics application.

FIG. 13A is an exemplary active load deliveries screen of the logistics application.

FIG. 13B is the active load deliveries screen showing a facility for accessing a loading site.

FIG. 13C is an exemplary site access screen of the logistics application.

FIG. 14A is an exemplary dashboard showing job creation and assignment notifications.

FIG. 14B shows the dashboard with a facility to submit updates for a particular job.

FIG. 14C shows the dashboard with exemplary notification cards for adverse job conditions.

FIG. 14D shows the dashboard with an exemplary notification card for the final stages of a load delivery.

### DETAILED DESCRIPTION

Disclosed is a platform incorporating various systems, methods, and/or devices including computer programs encoded on computer storage media, for optimizing trucking supply chain logistics. The disclosed embodiments may comprise a server accessible via a client application, which may be installable and executable on stakeholder devices, such as computers, smartphones, and tablets. Additionally, or alternatively, the client application may be provided as one or more web applications accessible via a client device having an internet browser.

The platform integrates with current trucking workflow and provides a digital marketplace through which various stakeholders may manage load deliveries and share information with other stakeholders. Stakeholders in a trucking supply chain may include, but not be limited to: drivers, carriers, dispatchers, receivers, shippers, and brokers. Though the platform and examples thereof described herein are directed towards a trucking supply chain, the platform may be similarly used for other delivery systems, such as mail delivery, residential/commercial package delivery, or food couriers.

Among other functions, the platform allows stakeholders to create/update a personal profile, create/update a company profile, create/update a loading site profile, upload license or certification information, create load delivery requests, assign load delivery requests, accept load delivery requests, track status events associated with a load delivery, upload relevant load delivery information, and manage communications with other stakeholders. Through the platform, the stakeholders may be able to track load metrics in real time as the load propagates through a supply chain and may establish direct lines of communication with other stakeholders to facilitate communication of text/image updates, ensure timely loading/unloading, and sign/submit bills of lading.

The platform also provides an access control feature that allows loading site owners to extend secure access to drivers associated with a load being delivered to the loading site. For example, if the loading site provides the proper equipment, the loading site owner may provide the driver authorization to use said equipment to load/unload at the loading site.

Additionally, the platform utilizes an optimization module incorporating one or more computer-implemented methods of optimizing trucking supply chain logistics. In one or more embodiments, the platform may recognize actionable correlations between load delivery status events induced by user activity in the client application and past/present metrics such as driver payment, location, weather, traffic, vehicle weight, freight classification, distance, fuel prices, excess capacity, road construction, terms of delivery, and loading site information (e.g., delivery windows, policies and procedures, access control). These actionable correlations may be recognized based on a predetermined threshold of statistical significance and may manifest as, for example, UI changes in the client application that are meant to influence user activity in the form of further status events.

### Definitions

‘Job’ refers to a task, usually a delivery task involving a load that is picked up by a driver at a pick-up point and dropped off at a drop-off point.

‘Status event’ refers to a change in the status of a job, which is typically created by user activity. Status changes for a particular job include, but are not limited to: job creation, job assignment (i.e., to a driver), job acceptance (i.e., by the driver), job start, job exception, site arrival, site access, image added, video added, comment added, job delivery, and Bill of Lading uploaded.

‘Metrics’ refer to data relevant to a load delivery within a supply chain that can be used to aid in facilitating the load delivery. Metrics can refer to, among other data, payment to the driver, location, weather, traffic, weight, freight classification, distance, fuel prices, excess capacity, road construction, and terms of delivery.

‘Stakeholder’ refers to individuals and/or companies that play a role in the completion of a job.

For the purposes of the present disclosure, ‘roles’ may refer to the following entities typically involved in a supply chain:

Driver: any operator of a truck of any classification (Class 1-8) that may work independently or through a carrier. However, ‘driver’ may also be used broadly to include operators of any vehicle performing a load delivery function, such as couriers
Carrier: a transportation company comprising drivers and dispatchers
Dispatcher: commonly an employee of a carrier that provides instructions to drivers and performs customer service for receivers and shippers
Receiver: an individual or company that makes orders for goods and receives loads with such goods from drivers at one or more drop-off locations (e.g., a retailer)
Shipper: an individual or company that distributes goods through loads picked up by drivers at one or more pick-up locations (e.g., a manufacturer)
Broker: an individual or company that may or may not have assets, but acts as a middleman between carriers/drivers/dispatchers and receivers/shippers. The platform may be suited for performing this role in some capacity.

Any other roles within any supply chain, including courier delivery, inter-modal transport and residential/commercial delivery, are within the scope of the exemplary embodiments described herein. Other roles, such as serviceman roles that can benefit from receiving access to a site but are not typically part of a supply chain are also be within the scope of the exemplary embodiments described herein.

‘Pending load’ refers to a load delivery that has been scheduled but has not yet been assigned to and/or accepted by a driver.

‘Active load’ refer to a load that is currently being delivered by a particular driver and for which a Bill of Lading has not yet been submitted.

‘Job creator’ refers to any stakeholder that may schedule a load delivery through the platform.

‘Pick-up point’ or ‘origin site’ refer to a location where a driver receives a load.

‘Drop-off point’ or ‘destination site’ refer to a location where a driver delivers a load.

### System Overview

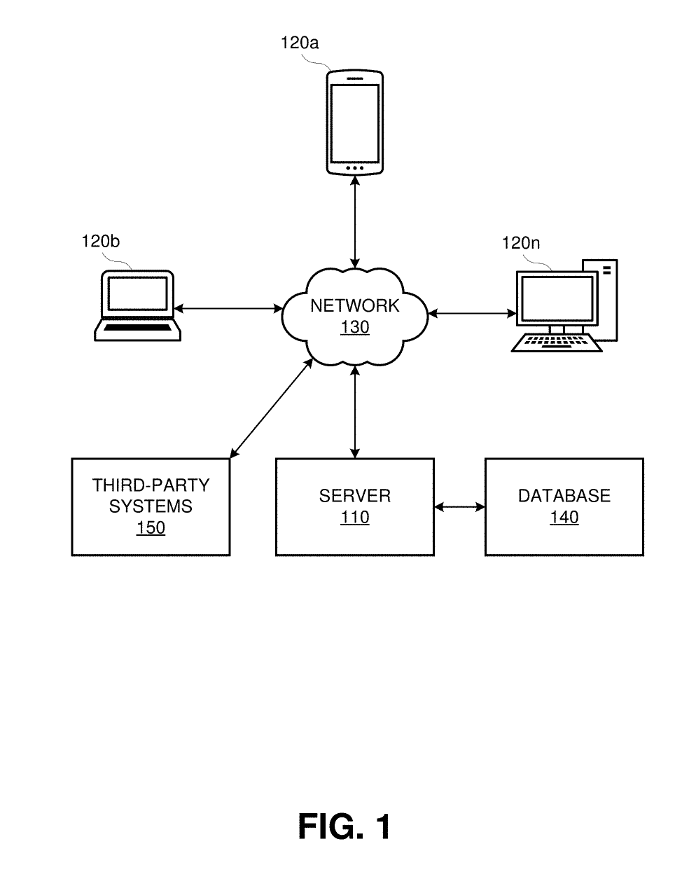

Referring to FIG. 1, an exemplary platform 100 for managing and optimizing trucking logistics is shown. The platform comprises any number of user devices (120a, 120b, 120n) operated by various users (e.g., drivers, carrier, dispatcher, receiver, shipper, broker, etc.) and accessing a server 110 via a network 130 (e.g., Internet, LAN, cellular, intranet, etc.). As discussed below, a user device may be any device capable of accessing the server 110, such as by running a client application or other software, like a web browser or web-browser-like application. Exemplary user devices include, but are not limited to, general purpose computers, desktop workstations, laptops, cell phones, smartphones, personal digital assistants, televisions, tablets, and the like.

The server 110 may be adapted to receive, determine, record and/or transmit information for any number of users. Such information may be manually entered or selected by a user via an online, mobile or desktop application. Such information may additionally or alternatively be automatically received from any of such devices. The server 110 may store received or determined information in, for example, a database 140.

In one embodiment, the server 110 may be connected to one or more third-party systems 150 via the network 130. Third-party systems 150 may store information in one or more databases that may be accessed by the server 110. Third-party systems 150 may include, but are not limited to, current weather and forecast collections, historical weather collections, traffic data collections, on-line job boards, certification and licensing databases, digital asset storage systems (e.g., Google Drive, iManage, Dropbox, Box, etc.), financial systems (e.g., billing, invoicing, and/or accounting systems), contact management systems, customer relationship management (“CRM”) systems, project and/or task management systems, 3PL software systems, communication systems, and others.

The server 110 may be capable of retrieving and/or storing information from third-party systems 150, with or without user interaction. Moreover, the server may be capable of transmitting stored information to third-party systems, and may notify users of such communications.

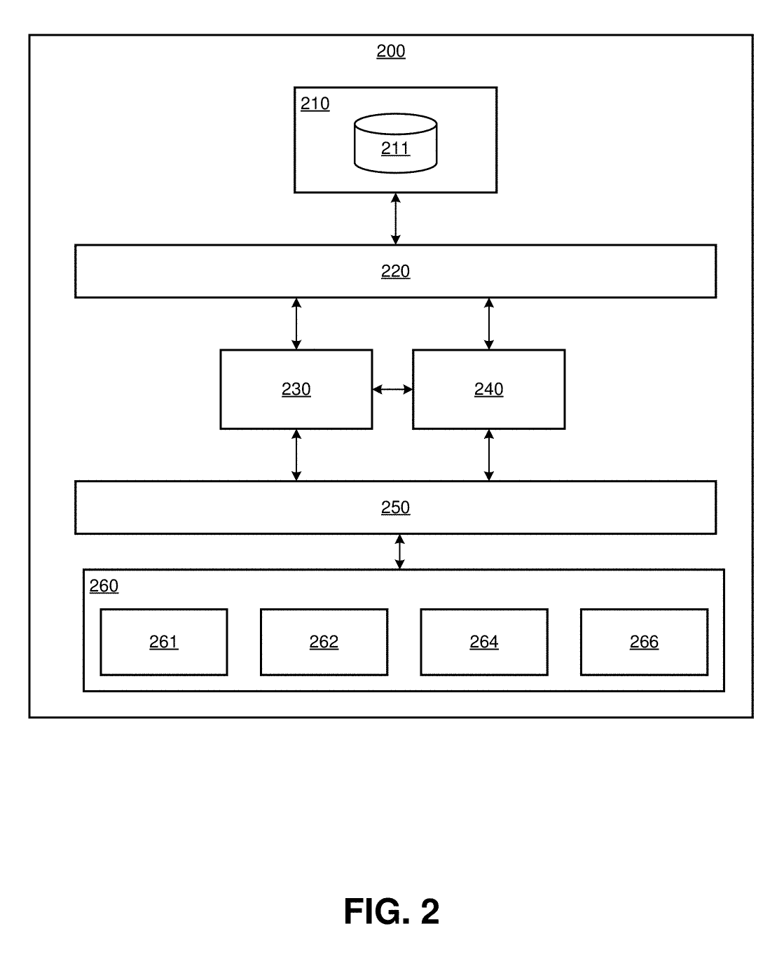

As shown in FIG. 2, the system may be entirely or partially implemented on one or more servers 200 each comprising hardware 260 such as any number of random access memory (“RAM”) 261, processor modules 262, and internal or external memory 264. The server 200 may include a network interface 266 such that it may access the network to send or receive information.

The server 200 may access a central data store 210 having at least one database 211. It will be appreciated that the database 211 may be internal to the server 200 or may be accessed by the server over the network or via another wired or wireless connection. The server may store desired or required information in the database 210 and may access the same to retrieve the information.

In certain embodiments, the database 210 may be in communication with an object relational mapping (“ORM”) 220, also known as an object relational model or object-relational database management system. The ORM may be in communication with a Universal Resource Indicator (“URI”) 230 mapper and/or a Rest API generator 240.

The URI mapper 230 may map a URI into a pointer to an internal program, view, logic, or presentation of data within the system, based on one or more rules of a matching object specified in a collection of mapping objects. The URI mapper 230 may be in communication with a web server.

The Rest API 240 generator may be in communication with a web server so as to send and/or receive data to/from user devices communicating with the server using HTTP and/or HTTPS. The Rest API 240 generator may prepare data stored in the database 210 for delivery to a client device or may prepare data received from a client device for storage in the database 210. The Rest API may be capable of translating between formats including, but not limited to JSON, XML and the like. The Rest API may be capable of automatically generating URIs based upon data structures observed in the ORM 220 for access by client devices.

A web server 250 may be adapted to deliver web pages on request to users using the Hypertext Transfer Protocol (HTTP and/or HTTPS) or similar protocols. This allows for delivery of HTML documents and any additional content that may be included by a document, such as images, style sheets and scripts.

In one embodiment, a user or client device may employ a web browser or similar client application to engage in communication with a web server 250. For example, a client application may make a request for a specific resource using HTTP/HTTPS and the web server may respond with the content of that resource or an error message if unable to do so. The resource may be data or a file stored in a database. The web server can receive content from a user, possibly using HTTP/HTTPS.

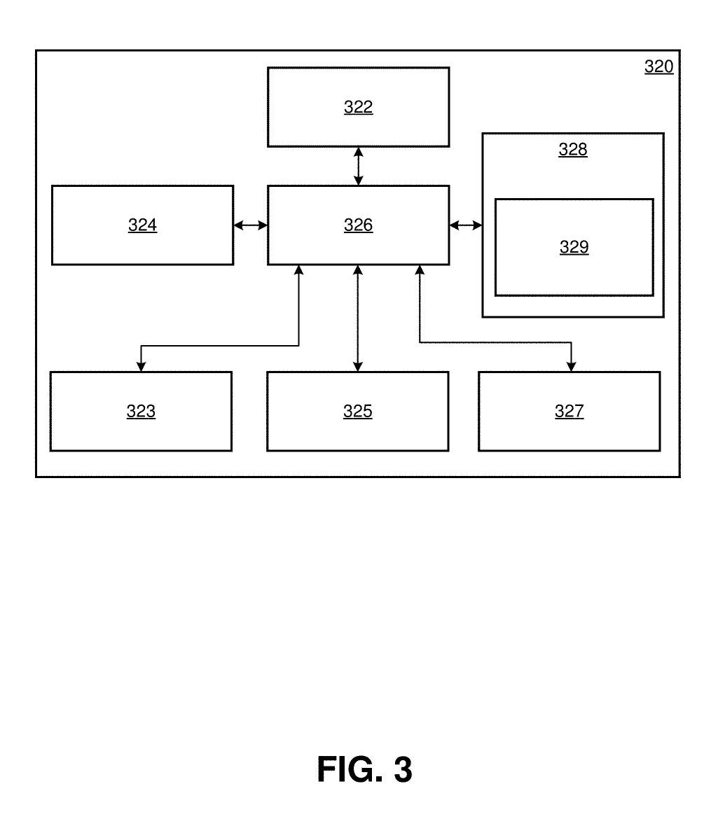

Referring to FIG. 3, a user device 320 is illustrated. Exemplary user devices include, but are not limited to, general purpose computers, laptops, cell phones, smart phones, personal digital assistants, televisions, tablets, and the like.

As shown, the user device 320 may comprise one or more wireless and/or wired network interface modules 322, one or more camera modules 323, one or more display modules 324, one or more user input interfaces 325, one or more processor modules 326, one or more SIM/user associated modules 327, and/or one or more memory modules 328. Additional modules may include an input/output device, a location sensor, and/or audio equipment.

Each user device 320 may have one or more client applications 329 stored in its memory module 328 and executable by the processor module 326, where each client application 329 may be adapted to communicate with a trucking supply chain application running on the server 310 over, for example, a network. Additionally, or alternatively, the client applications 329 may be available as one or more web applications, accessible via the client device 320 having an internet browser. Such configurations may allow users of client applications 329 to input information and/or interact with the trucking supply chain application from any location that allows for access to the server 210.

As discussed in detail below, exemplary client applications 329 allow for logistics management, logistics optimization, and site access control. To that end, the client application may be adapted to present various user interfaces to users. Such user interfaces may be based on access privileges and/or information sent by the system, and may allow the user to send and receive data. Exemplary client applications may comprise HTML data, images, icons, and/or executable code. The executable code may be composed in JavaScript, ECMAscript, coffeescript, python, Ruby or other programming languages suitable for execution within the client application, or translation into a client application executable form.

It will be apparent to one of ordinary skill in the art that, in certain embodiments, any of the functionality of a client may be incorporated into the server, and vice versa. Likewise, any functionality of a client application may be incorporated into a browser-based client, and such embodiments are intended to be fully within the scope of this disclosure. For example, a browser-based client application could be configured for offline work by adding local storage capability, and a native application could be distributed for various native platforms via a software layer that executes the browser-based program on the native platform.

In one embodiment, communication between a client application and the server may involve the use of a translation and/or serialization module. A serialization module can convert an object from an in-memory representation to a serialized representation suitable for transmission via HTTP or another transport mechanism. For example, the serialization module may convert data from a native Python, Ruby, or Java in-memory representation into a JSON string for communication over the client-to-server transport protocol.

Similarly, communications of data between a client device and the server may be continuous and automatic, or may be user-triggered. For example, the user may click a button, causing the client to send data to the server. Alternately, a client application may automatically send updates to the server periodically without prompting by a user. If a client sends data autonomously, the server may be configured to transmit this data, either automatically or on request, to additional clients.

It will be recognized that any other suitable software, hardware or combinations thereof may be used with the exemplary systems and applications disclosed herein. Moreover, such applications may be implemented at any suitable location, such as but not limited to the server, a third-party system, at one or more user devices or at a location not shown.

### Trucking Logistics Management and Optimization Application

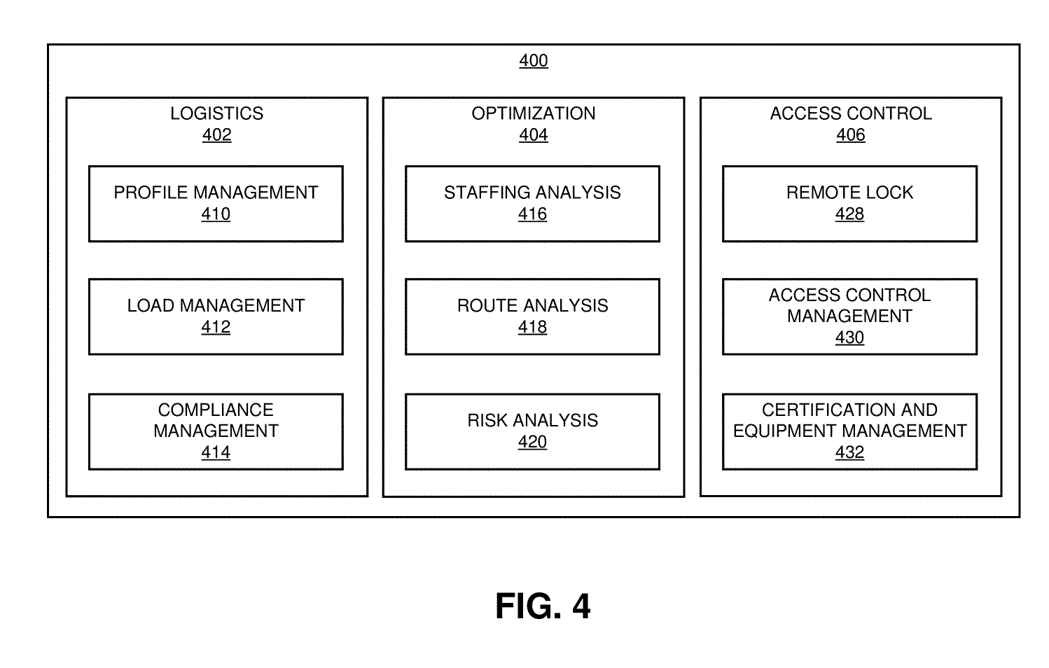

Referring to FIG. 4, a block diagram is presented showing a number of integrated modules of an exemplary trucking logistics management and optimization application 400. As shown, the application 400 may comprise a logistics module 402, an optimization module 404, and an access control module 406.

In one embodiment, the logistics modules 402 allows for profile management 410, load management 412, and compliance management 414.

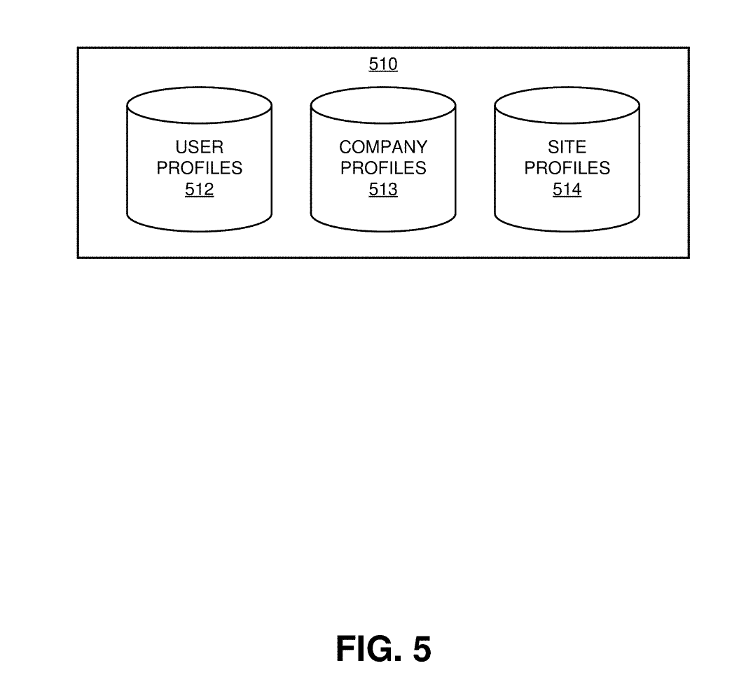

Referring to FIG. 5, exemplary profile databases are shown. The central data store 510 may comprise a personal profiles database 512, a company profiles database 513, and a site profiles database 514. Profile data can include personal profile data, company profile data, and site profile data.

Personal profile data comprise user information, including at least the name and the role of the user and any licensing and certification information for the user. Company profile data comprise company information, including at least the name, address, and phone number of the company. Site profile data comprise loading site info, including location, policies/procedures, delivery hours, and available equipment for use by drivers. Though all users would have a personal profile, not all users may be associated with a company profile. Certain roles, such as carriers, dispatchers, receivers, shippers, and brokers would be associated with a company profile and with the exception of most brokers, would typically also be associated with at least one site profile.

Referring back to FIG. 4, load management 412 allows stakeholders to schedule a load delivery, assign the delivery to available drivers, view and update active loads, and access a dashboard that functions as a notifications feed for all active loads associated with the stakeholder. Load management also allows the various stakeholders of a pending load to send, upload and access up-to-date information regarding the load delivery, such as current location, text/image updates from stakeholders, weather conditions, delivery status (e.g., on route, delayed, awaiting signature, etc.), feedback/ratings/reviews, documents (such as Bills of Lading), and other relevant information.

Compliance management 414 allows the platform to ensure careful compliance with applicable national and state laws and regulations as well as policies and procedures set in place by other stakeholders. For example, compliance management 414 can ensure a loading site owner provides adequate signage, or that a loading site be equipped properly for unloading by drivers arriving after-hours. In another example, compliance management 414 may notify a driver of an imminent license or certification expiration date.

In another embodiment, the optimization module 404 provides an analytical framework for determining and meeting staffing requirements 416, optimizing routes 418 for load delivery, and determining a liability risk 420 of a particular load, among other optimization functions. The optimization module 404 may involve influencing status events in the application by responding to particular data received through the application and/or by third-party systems.

Staffing analysis 416 allows the application to match a driver (or other vehicle/equipment operator) with a particular set of certifications to a job according to the staffing and compliance needs of the job's load delivery, or according to the relative decrease in liability risk that the job is purported to incur based on the driver's past history through the platform.

Route analysis 418 allows the application to reroute a particular load delivery automatically based on weather, the driver's proximity to law enforcement, the driver's availability to accept another job and pick up another simultaneous load at a nearby loading site, heavy city traffic, relevant changes to destination site policies and procedures, or other data that may be derived from stakeholder activity through the app or data derived from third-party systems.

Risk analysis 420 allows for liability of a particular load delivery to be calculated. This calculation may involve details surrounding the origin site, the destination site, the driver, the driver's vehicle, potential damage due to weather, and other factors that are usually involved in determining risk for load delivery through a trucking supply chain. Risk analysis 420 may be provided by the application or may be manually performed by stakeholders and may be used, for example, to inform an insurance broker of the degree of risk to aid in brokering an appropriate insurance premium.

Based on these features, the optimization module 404 can dynamically introduce influences to user behavior that can dramatically optimize activity throughout the platform.

In another embodiment, the access control module 406 provides drivers with the ability to unlock, through the application, a remote lock 428 registered with the platform. Access to the remote lock 428 is typically limited to stakeholders associated with the load, especially drivers. Without such a feature, drivers forced to deliver a load outside a retailer's delivery hours, due to traffic, weather, or supply chain inefficiencies, would otherwise wait until the loading site opens during operational hours. During the wait time, the driver could be picking up and/or delivering another load.

The access control module 406 also provides certification and equipment management 432. Even if off-hours access to a load site is available, drivers are generally unable to operate on-site loading equipment and vehicles, such as a forklift. Most drivers are certified to work with most heavy equipment, including forklifts, and are capable of loading and unloading their trucks without assistance. The access control module 406 enables an end-to-end solution that drives velocity through the supply chain by giving drivers secure, accountable access to loading sites and equipment/vehicles therein.

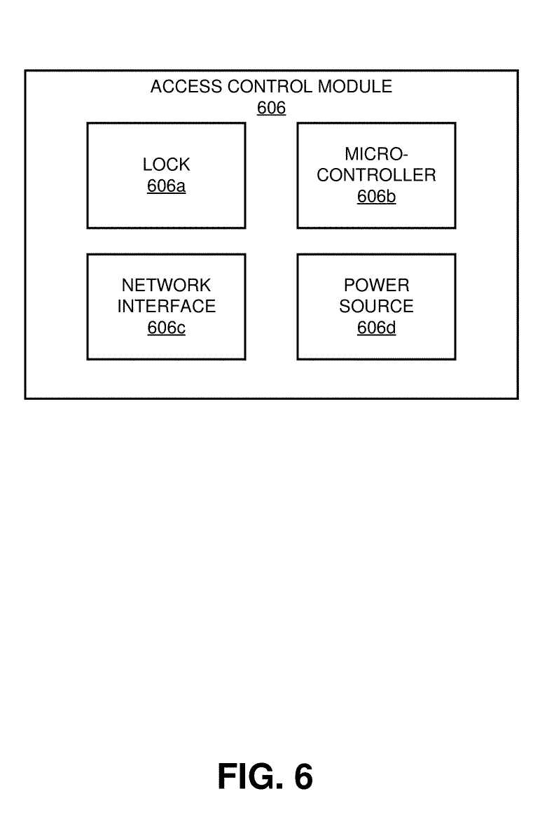

Referring to FIG. 6, an exemplary access control module is shown. In one or more embodiments, an access control module 606 comprises a lock 606a, a microcontroller 606b, a network interface 606c and a power source 606d. The lock 606a may be any electromechanical latch or strike configured to disengage upon receiving a control signal. The microcontroller 606b comprises at least one processor and at least one data store. The network interface 606c enables the access control module 606 to access networks and communicate with other data processing devices. The power source 606d provides power to the other components of the access control module 606.

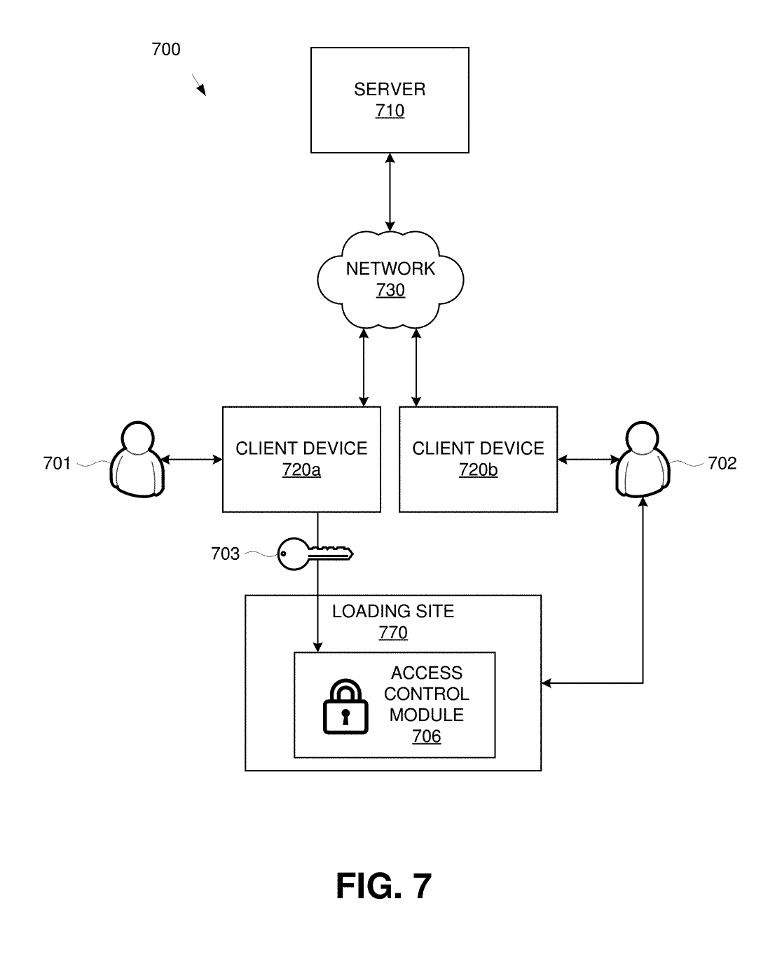

Referring to FIG. 7, a block diagram of an exemplary access control system 700 is shown. The access control module 706 allows a stakeholder with a client device 720 to gain encrypted access to a loading site 770. Such encryption may be, for example, 128-bit AES encryption. A stakeholder having a loading site 770 may register the access control module 706 with the platform. The stakeholder may provide, through the platform, authorization to unlock the access control module 706 to other stakeholders involved in load delivery to/from the loading site 770. Or, the platform may automatically provide encrypted access to stakeholders assigned to the delivery through the platform.

Loading sites 770 generally have operating hours (also ‘delivery window’) during which the loading site 770 accepts pick-ups and deliveries. However, a receiver/shipper has little incentive to extend a delivery window, since overtime pay for security personnel to man the loading site usually outweighs the benefits of an overnight delivery. However, security personnel are typically onsite to ensure driver compliance with loading site policies and procedures, operate heavy equipment such as forklifts, and perform other tasks. Overall, the driver, the most functional unit of a supply chain, is hit the hardest: drivers typically wait until the delivery window reopens to complete their pickup/delivery.

Off-hours delivery (i.e., outside the delivery window) is possible with the platform. The platform allows a loading site 770 to be accessed by drivers with authorization to unlock an access control module 706 of the loading site 770. In one embodiment, to obtain access, a driver 701 may communicate a request to the server 710 using a client device 720a.

In one embodiment, the request may be forwarded by the server 710 to a client device 720b of an owner 702 of the loading site 770. The owner 702 may grant the request and the server 710 may receive notification of the same. The server 710 may subsequently provide the client device 720a the requisite session identifier, session key, and/or unique digital key 703 that may be transmitted to the access control module 706 to provide access to the loading site 770.

In another embodiment, upon receiving the request, the server 710 may automatically provide the key 703 if the driver 701 is included in a whitelist associated with the load that is being delivered to the loading site 770. For example, the owner 702 may have created the site profile associated with the loading site 770, created the job associated with the load through the platform, and assigned the job to the driver 701 through the platform.

It is important to note that the access control module 706 does not communicate directly with the server 710 through the network 730. The access control module 706 is preferably not directly connected to wide area networks, such as the Internet, due to the potential harm that malicious access may cause. As such, to eliminate such a liability, a direct connection through a local area network (such as WiFi™ or Bluetooth) by a device in the vicinity of the access control module 706 is preferable.

Driver Vs. Administrator Perspective

The client device 104 may execute a mobile application that provides stakeholders access to the platform by providing various user interface screens.

Though in most embodiments stakeholders may view similar user interface screens, in some embodiments, stakeholders may experience modified user interfaces. The user interfaces may be modified to, for example, better suit the user's role, associated site/company policies, the relevant industry the stakeholder is involved in, or the particular load being delivered.

For example, the application may provide user interface views that are geared toward drivers and that limit overall interaction with the client device. Or, the application may be sensitive to the safety needs of a particular shipper's merchandise and require more detailed accountability throughout the load delivery process, in the form of, for example, timely updates, image uploads, and bill of lading submission.

Other modifications to the user interface views may involve providing a broker the ability to provide authorized access to a loading site for a fellow stakeholder. Or, a dispatcher may access additional visual tools for engaging with stakeholders and data from multiple simultaneous load deliveries.

As far as ensuring a proper load delivery process through the platform, the application may provide a process by which job creators may create jobs by scheduling a load delivery and assigning the job to a driver.

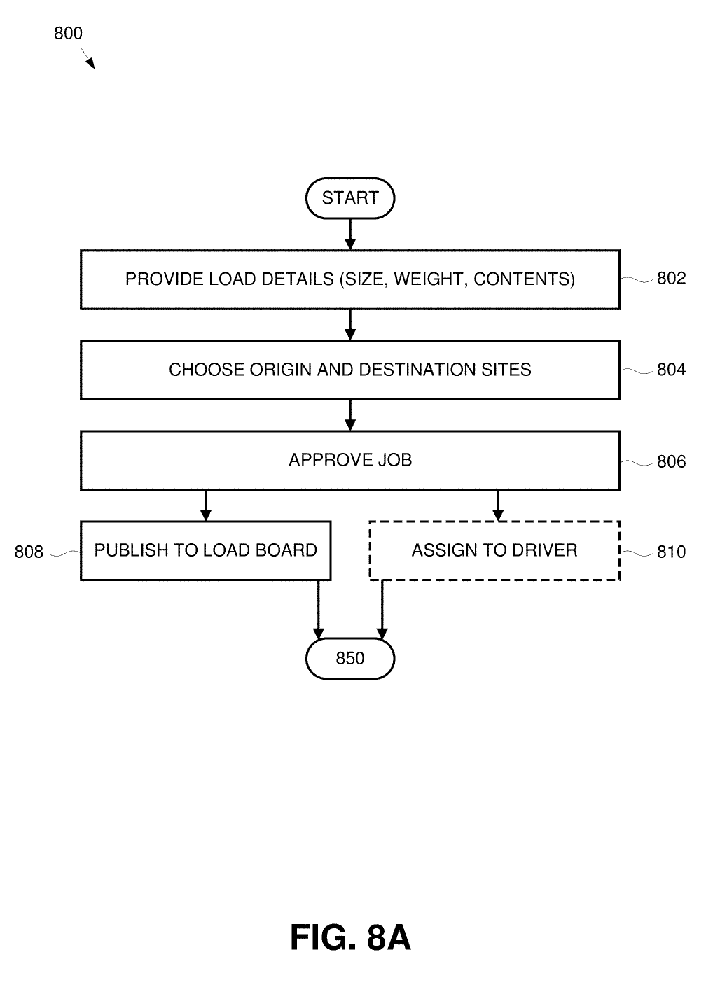

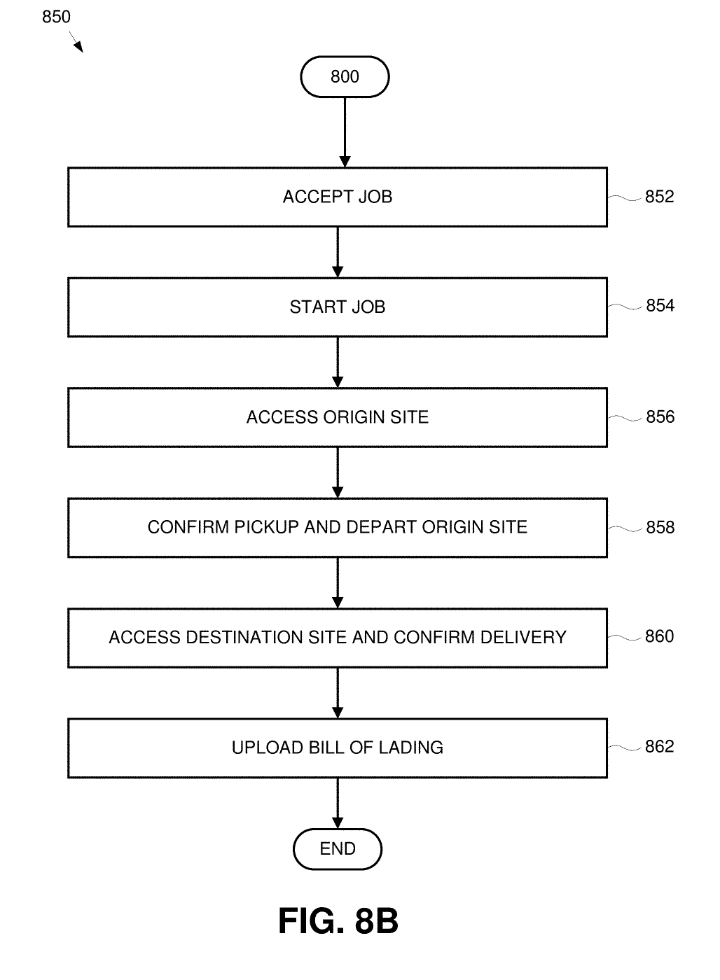

Referring to FIG. 8A, a method diagram illustrating an exemplary job creation process 800 is shown. The job creation process 800 may be completed by ‘job creators’ or any stakeholder typically involved in scheduling a load delivery, such as a receiver, shipper, carrier, dispatcher, or broker. In a step 802, a job creator may provide load details, such as a size of the load, a weight of the load, a description of the contents of the load, and other details. In a step 804, the job creator may choose an origin site and a destination site. This may involve choosing from a list of loading sites, using a map to locate a loading site, or providing geocoordinates.

In a step 806, the job creator and other stakeholders (e.g., origin and destination site owners) may approve the job, at which point the job creator may publish the job to a load board in a further step 808 or assign the job to a driver in a further step 810. The load board may be a digital bulletin that may be viewable by driver and include a list of pending loads that must be executed by a driver. If assigned to a driver as in step 810, the driver's name may be searched by name or selected from a list of available drivers. In any case, the process continues to an exemplary load delivery process.

In another embodiment, the job creation process may be geared toward a service-oriented task, such as repairing a furnace, in which case the job creator may choose only an origin site in step 804 and in step 810, assign the job to an appropriate serviceman registered with the platform.

Referring to FIG. 8B, a method diagram illustrating an exemplary load delivery process 850 is shown. During the load delivery process 850, the driver performs various tasks through the application that allow stakeholders to be apprised of the load delivery status in a timely manner. In a step 852, the driver may accept a job, i.e., accept to deliver a particular load described in a job created by a job creator through a job creation process 800 as described in FIG. 8A. Upon accepting the job, and optionally receiving an authorization by the job creator, in a step 854, the driver may officially start the job, at which driver may start on a route to the origin site. Upon reaching the origin site, the driver may confirm accessing the origin site in step 856. In step 858, the driver may confirm pickup and depart the origin site 858. In a step 860, the driver may access the destination site and confirm delivery 860 and subsequently upload the Bill of Lading (and/or any other necessary documentation) in step 862. Once the bill of lading is uploaded, the load delivery process 850 may be complete.

In another embodiment, a ‘job completion’ process may comprise only steps 852-856 and may be applicable to service-oriented jobs that may be created through the platform. In such a process, a service worker (e.g., a repairman) may accept a service job in step 852, start the job in step 854, access the origin site 856, and in step 860 only confirm completion of the job.

### Application User Interface Screens

The application may facilitate the above processes through one or more user interface screens. Upon executing the application, the user may be prompted to provide his/her user credentials to login to the application. A new user may be prompted to fill out one or more profiles (e.g., a personal profile, a company profile, and a site profile).

All individual users would register a personal profile to provide basic identification information. However, an administrator of a company (e.g., a retailer, a carrier, or a broker) may establish an administrative user account for the company by also completing a company profile. If a user is an employee of the company, that user may request an invitation from the administrative user account to associate with the company.

Certain individuals may also own a loading site and would complete a site profile. The primary purpose of a loading site profile is to centrally store contact information for site personnel, images of the site, and/or current policies and procedures. These data can be viewed by a stakeholder, i.e., during a load delivery.

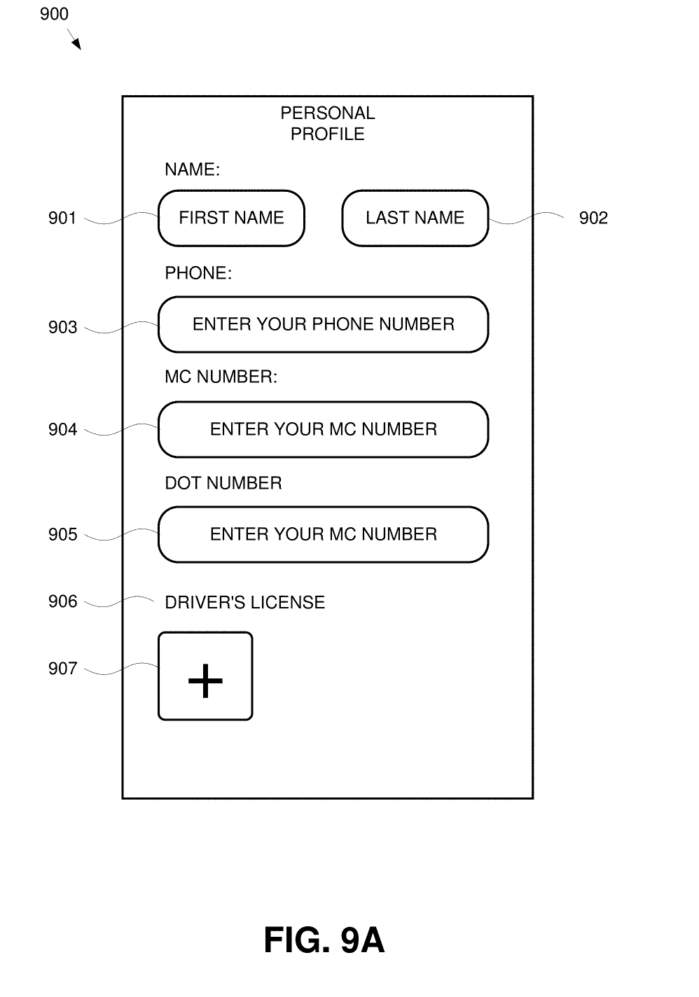

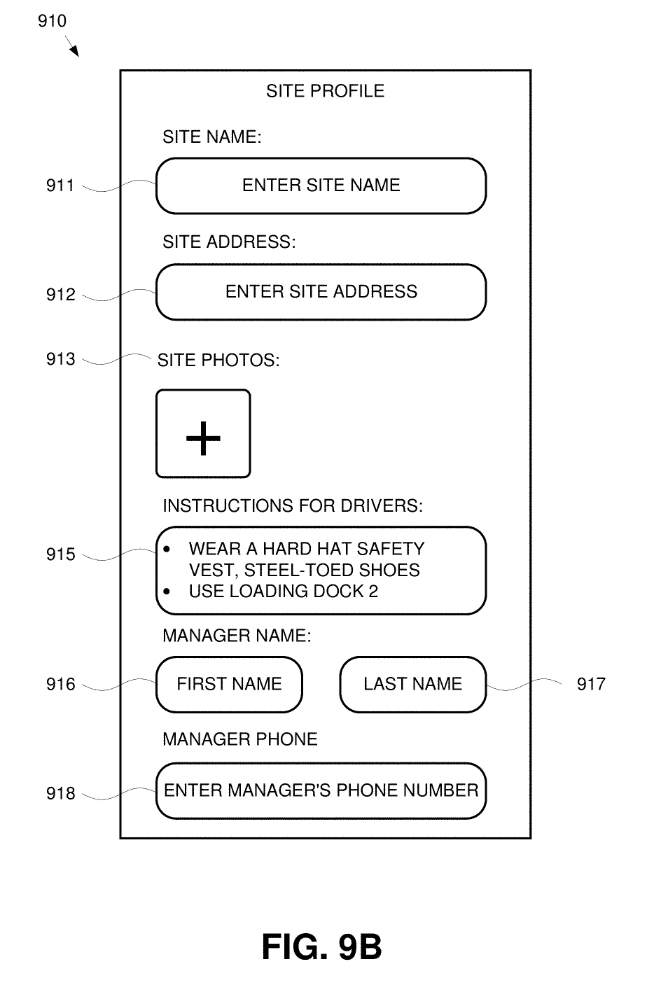

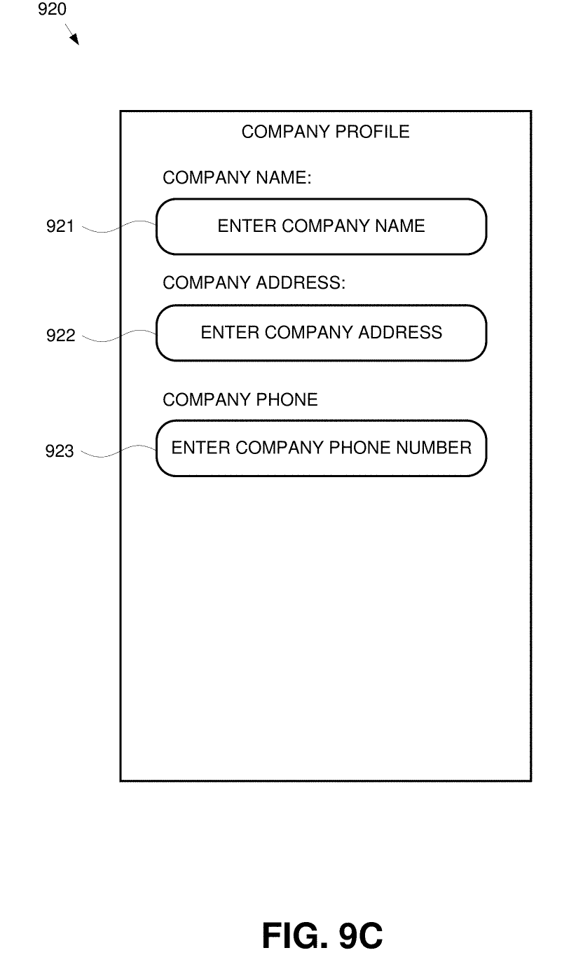

Referring to FIG. 9A, an exemplary personal profile screen 900 of the logistics application is shown. Relevant personal information may include a first name 901, a last name 902, a phone number 903, a Federal Motor Carrie Safety Administration Authority (MC) number 904, a Department of Transportation (DOT) number 905, and a driver's license 906 (i.e., an image of which may be uploaded by selecting an upload photo button 907).

The user may also be prompted to select or enter at least one industry within which the user works. Selecting an industry may modify the interface views experienced by the user in order to more seamlessly integrate with the user's workflow. Example industries include, but are not limited to: agriculture, forestry, fishing and hunting; mining, quarrying, and oil and gas extraction; utilities; construction; manufacturing; wholesale trade; retail trade; transportation and warehousing; information; finance and insurance; real estate and rental and leasing; professional, scientific, and technical services; management of companies and enterprises; administrative and support and waste management and remediation services; management of companies and enterprises; educational services, health care and social assistance; arts, entertainment, and recreation; accommodation, food, and beverage; consumer household services; and other services (except public administration). Establishing a personal profile through the personal profile screen may also generate an internal profile number, or Unique ID. The Unique ID may be associated with the user when the user is referred to throughout the mobile application.

Referring to FIG. 9B, an exemplary site profile screen 910 of the logistics application is shown. A stakeholder that also owns a loading site may be prompted to create a loading site profile. For example, a retailer receiving shipments may own one or more loading sites.

Loading site owners may find that storing up-to-date loading site information through the platform may be a valuable way to centralize policies and procedures and make them accessible to other stakeholders involved with loads that pass through the loading site. Relevant site data may include, but not be limited to: site name 911, site address 912, site nickname, site photos 913 (with a facility to provide annotations to said photos, such as an arrow or a circle), instructions for drivers and/or dispatchers 915, manager first name 916 and last name 917, manager phone 918, and manager email address. Other site data relevant to the user's specific workflow may be entered. Updates to this data may be propagated to all users associated with the loading site.

Instructions for drivers may involve instructing the driver to wear a particular article of safety clothing (such as a hard hat, safety vest, steel-toed shoes, etc.) or to navigate around an obstacle. Also, site warnings may be provided through the site profile, such as emergency situations (presence of a snow bank, spill, vehicle accident, etc.)

Referring to FIG. 9C, an exemplary company profile screen 920 of the logistics application is shown. An administrator of the company may use this screen to organize logistics with other stakeholders at the same company. Relevant company info may include company name 921, company address 922, and company phone number 923.

The above-mentioned profile screens may be used not only to register a profile for the first time, but also to update profile information. In some embodiments, some profile information may be automatically updated based on certain situations. For example, instructions for drivers for a loading may be updated to include a weather warning if there is severe weather around the loading site.

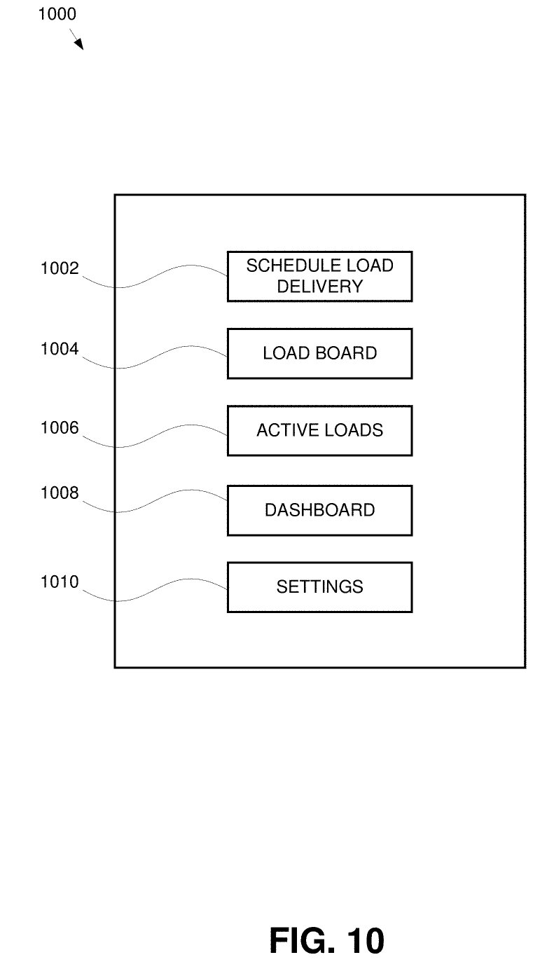

Referring to FIG. 10, an exemplary navigation screen 1000 of the logistics application is shown. As shown, the navigation screen 1000 provides a number of links to various screens of the application, including links to: a load delivery scheduling interface 1002, a load board interface 1004, an active loads interface 1006, a dashboard interface 1008, and a settings interface 1010. The settings interface 1010 may provide an ability to toggle receiving notifications, toggle location services, edit an associated personal/company/site profile, and adjust job preferences. For example, a driver may adjust job preferences by reducing a distance the driver is willing to drive to pick up a load at an origin site.

The navigation screen 1000 as shown in FIG. 10 may show buttons that users of particular roles may or may not experience in the course of their use of the application. For example, a driver may not be able to schedule a load delivery because that feature is not intrinsic to the driver's role.

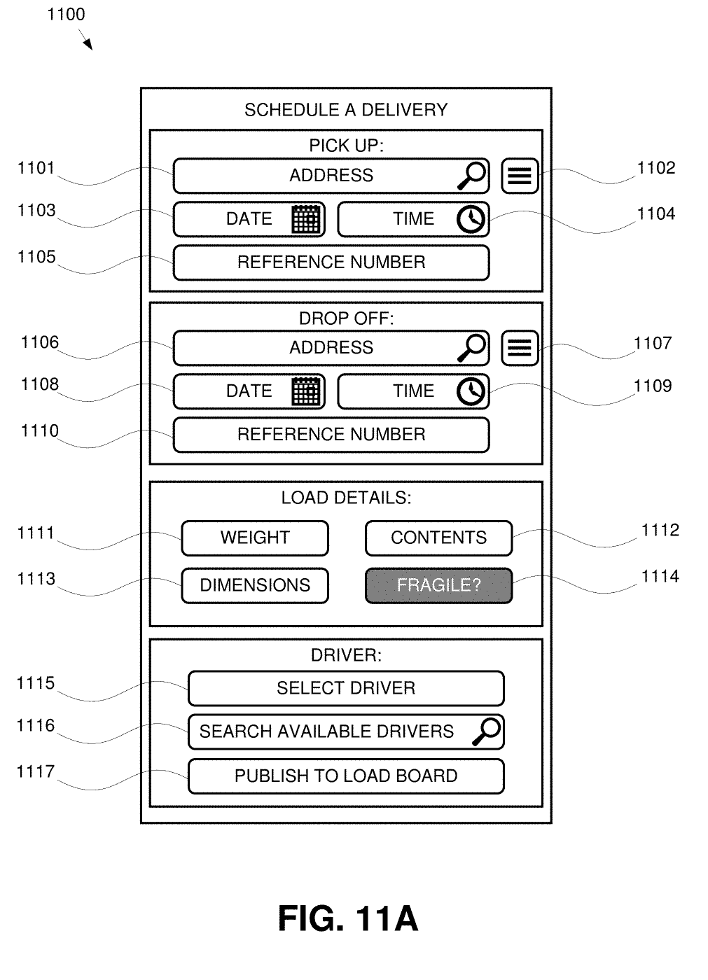

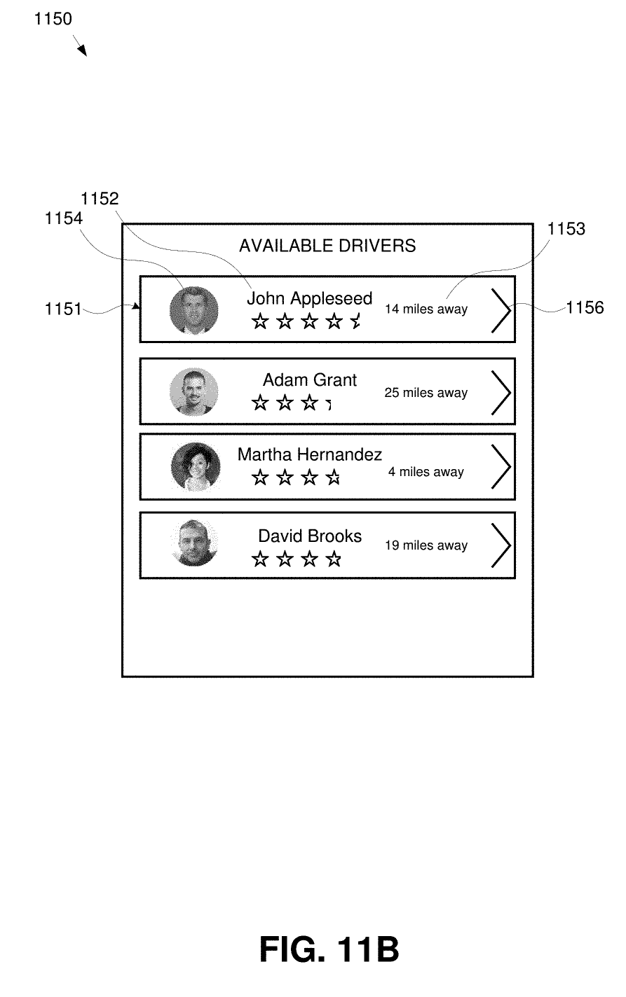

Referring to FIG. 11A, an exemplary load delivery scheduling screen 1100 of the logistics application is shown. Generally, the load delivery scheduling screen 1100 allows a job creator to provide details for the load delivery, including but not limited to pick-up details, drop-off details, load details, and driver details.

Specifically, the job creator may utilize keyword search for a pick-up address 1101 or select a pick-up address from a list of loading sites registered with the platform by selecting the loading sites lists button 1102. The job creator may also select a pick-up date 1103, and a pick-up time 1104. Optionally, the job creator may also provide a reference number 1105, which may correspond with an internal number, a PO number, a bill of lading number, or other number. The job creator may similarly pick analogous data for the drop off point, including the drop off address 1106, access to a list of loading sites 1107, a drop off date 1108, a drop off time 1109, and an optional reference number 1110.

The reference number and Unique ID may actually be alphanumeric and may automatically increment based on a previously entered reference number. Alternately or in addition, entry of a reference number may prompt a list of previously used reference numbers, the delivery info of any of which may be used to populate the fields of the current delivery being scheduled, such as pick-up details, drop off details, load details, or driver details.

Load details may also be provided, such as the weight 1111 of the load, the contents 1112 of the load, the dimensions 1113 of the load, and a toggle button 1114 to indicate whether the load holds fragile goods. Based on the contents, particular compliance features may be applied to the job that limit, for example, the types of vehicles that can be used.

The job creator may also choose to select a driver 1115 from a list of drivers available through the platform. Or, the job creator may search available drivers 1116 by name, ratings, location, certification, and/or other metrics. Or, the job creator may choose to publish 1117 the scheduled delivery to a load board.

Referring to FIG. 11B, an exemplary driver selection screen 1150 of the logistics application is shown. The list of available drivers may be generated based on drivers that have been selected by the job creator in the past, drivers in the vicinity of the user, sponsored drivers, or any other metrics. Each driver of the list of drivers may be shown as a card 1151 displaying at least one or more of the following driver details: name 1152, distances from the origin site 1153, equipment type, location, availability, picture 1154, phone number, rating 1155, and other metrics. Information not shown in the card 1151 may be viewed by selecting the card 1151. The job creator may select a driver to deliver the load by selecting the select driver button 1156.

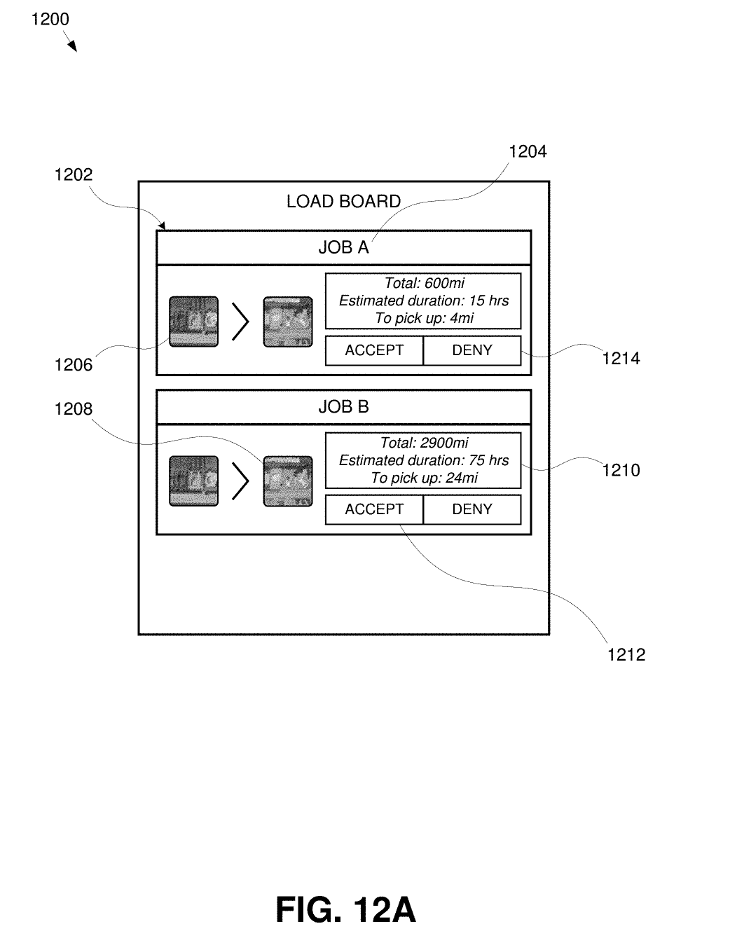

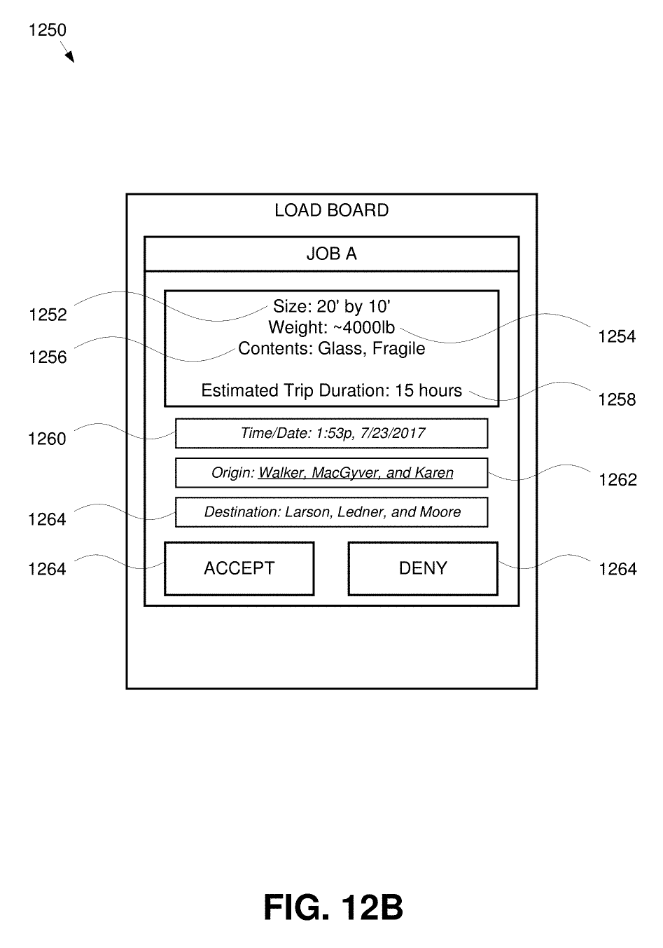

Referring to FIG. 12A, an exemplary load board screen 1200 of the logistics application is shown. Generally, the load board screen 1200 allows drivers to view and select pending loads submitted to the load board by a job creator, as described in the above job creation process. The load board screen 1200 may be accessed by, for example, selecting the “Load Board” option 1004 on the navigation screen 1000 (see FIG. 10).

As shown in FIG. 12A, the load board screen provides one or more pending loads 1202 shown as stackable cards. In one embodiment, the pending loads 1202 display load details, such as the job name 1204, origin satellite photo 1206, destination satellite photo 1208, a summary of the load logistics, an accept button 1212 and/or a deny button 1214. Selecting the deny button 1214 may cause the corresponding card to vanish and remaining cards to move to the top of the list.

Generally, the load board comprises load deliveries scheduled by a job creator (e.g., carrier, receiver, shipper, broker, dispatcher). Though all roles within the platform may be able to view the load board, only qualified drivers may be allowed to execute a load delivery published through the load board.

Referring to FIG. 12B, an exemplary pending load details screen 1250 of the logistics application is shown. Selecting the card associated with the pending load 1202 causes the application to display the pending load details screen 1250, where detailed information can be viewed, such as a size 1252 of the load, a weight 1254 of the load, a description of the contents 1256 of the load, an estimated trip duration 1258, a time/date of pickup 1260, the origin 1262, and the destination 1264. Selecting the origin 1262 or the destination 1264 may cause the application to display site profile details and a map of the corresponding loading site associated with the selected origin 1262 or destination 1264.

The job creator may be notified when the job is accepted by a driver. In one embodiment, the job creator may manually provide the driver authorization to proceed with the load delivery through the application. In another embodiment, the platform may automatically provide authorization to one or more drivers based on one or more factors, including past work history (e.g., with the job creator, with the job creator's company, with the particular contents of the load being delivered), automatic authorization for drivers associated with a particular company (e.g., a carrier, a broker), the driver's rating (e.g., overall rating, ratings provided by the job creator for past jobs), and others.

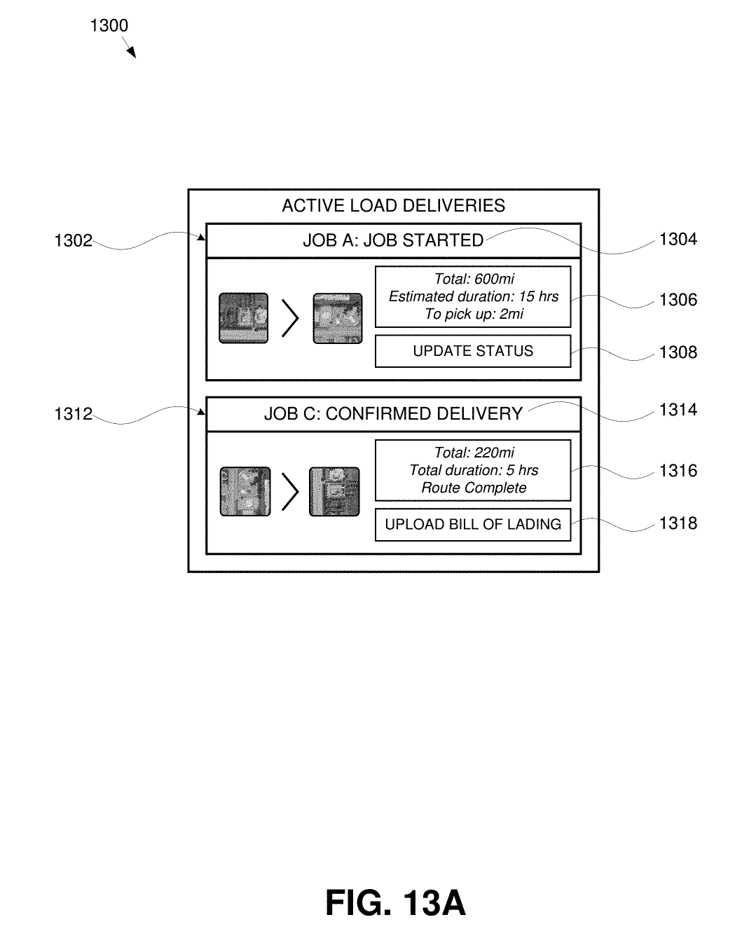

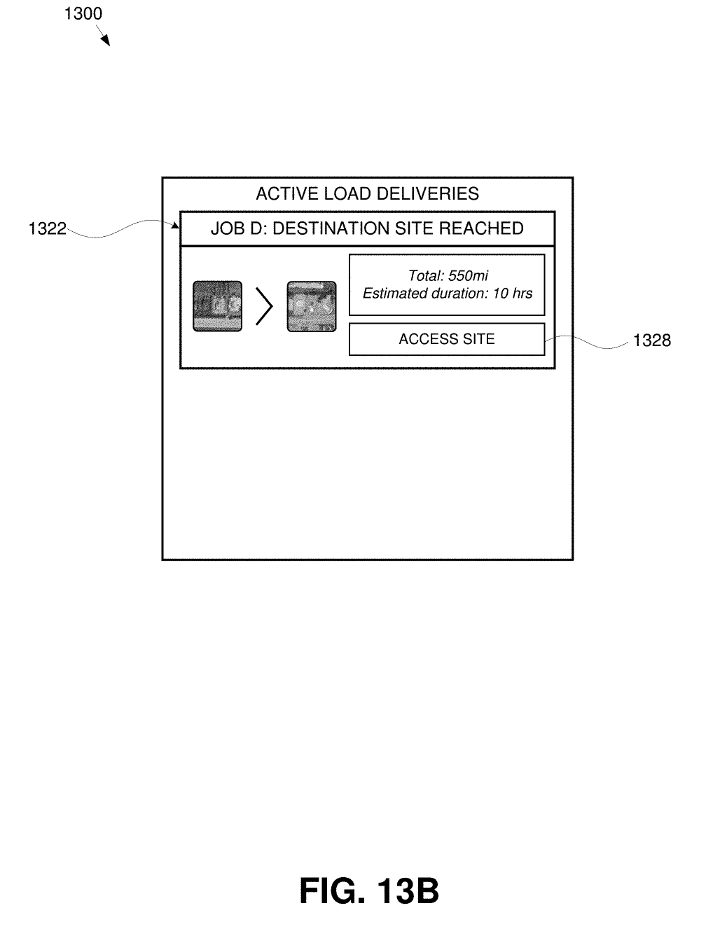

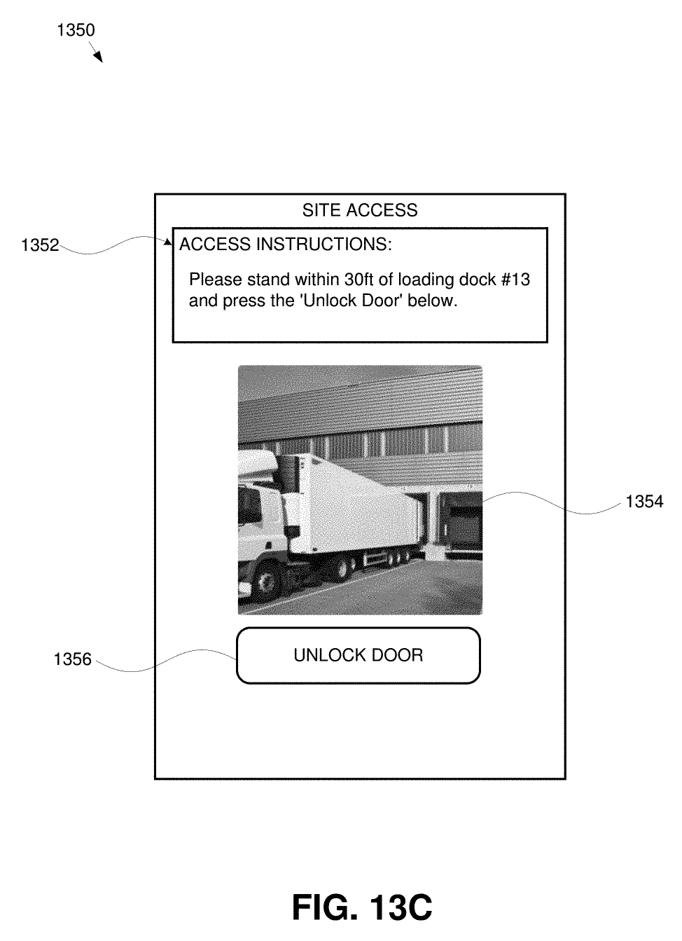

Referring to FIG. 13A, an exemplary active load deliveries screen 1300 of the logistics application is illustrated. Generally, the active load deliveries screen 1300 allows stakeholders to view and update the status of active loads. The active load deliveries screen 1300 may be accessed by, for example, selecting the “Active Loads” option 1006 on the navigation screen 1000 (see FIG. 10).

In one embodiment, the active load deliveries screen 1300 may display active load deliveries associated with the stakeholder. For example, a driver may utilize the active load deliveries screen 1300 to view and update the status of any active load deliveries.

As shown in FIG. 13A, the active load deliveries screen 1300 may comprise a card representing an active load 1302 entitled ‘Job A.’ As shown, a current status 1304 of Job A may be ‘Job Started,’ and the job details 1306 may display further status details, such as a total duration of the delivery, an estimated duration of the delivery, and a distance to the origin site (i.e., where the driver will pick up the load). A stakeholder (i.e., the driver, the job creator, the loading site owners) may update the status of the load delivery by selecting an ‘Update Status’ button 1308. For example, the driver may communicate a text update, upload an image, or manually proceed to the next stage of the load delivery process (i.e., origin site accessed according to FIGS. 8B and 13A). Or, the origin site owner may select the ‘Update Status’ button 1308 to communicate a text update to stakeholders that a particular policy at the loading site is changing before the driver will reach the loading site. Or, the job creator may choose to cancel the job at any point during the load delivery process.

In another embodiment, the application may be configured to periodically detect the location of the client device of the driver. As the active load progress through delivery, updates may be automatically generated based on the location of the driver (and presumably also the driver's vehicle and the load being delivered). For example, if the application detects that the driver's client device is approaching the origin site of Job A, the application may automatically update the current status 1304 of Job A to ‘Origin Site Reached.’ Subsequently, if the application detects that the driver's client device is leaving the origin site, the application may automatically update the current status 1304 to ‘Pick Up Confirmed.’

As shown in FIG. 13A, the active load deliveries screen 1300 comprises another active load 1312 titled ‘Job C’ that is at a separate stage of the load delivery process. As shown, the current status 1314 of Job C may be ‘Confirmed Delivery,’ and the job details 1316 may display that the route is complete (i.e., the driver has reached the destination site). The driver assigned to Job C may select a ‘Upload Bill of Lading’ button 1318, thus completing the load delivery process as described in FIG. 8B.

FIG. 13A shows multiple, simultaneously active load deliveries. This is possible because Job C's next stage (i.e., uploading the Bill of Lading) does not require the driver (nor the driver's vehicle) to be physically present at any loading site. As such, drivers can effectively schedule future load deliveries.

Referring to FIG. 13B, the active loads delivery screen 1300 is shown displaying an active load 1322 delivery in which the driver has accessed the destination site, and is able to provision access to the loading site through the application. In one embodiment, the driver may be able to access the destination site by selecting the ‘Access Site’ button 1328, which may utilize the access control process as described in FIG. 7.

Referring to FIG. 13C, an exemplary site access screen 1350 is shown. Generally, the site access screen 1350 allows the driver to gain access to a loading site through the application. The site access screen 1350 may be accessed by, for example, selecting the “Access Site” option 1328 on the active load deliveries screen 1300 of FIG. 13B.

In one embodiment, the site access screen 1350 may comprise instructions 1352 which may display any relevant information that may be associated with the loading site (please see FIG. 9B at 915). This screen may also provide a preview 1354 of the loading site. The preview 1354 may display a visual guide for the driver and may comprise a map of the loading site surroundings, a photo of the loading site as in FIG. 13C, and/or a video showing how to enter the site. The preview 1354 may also comprise annotations, such as a circle or an arrow.

Additionally, the screen may provide an ‘Unlock Door’ button 1356, which may be available if the loading site comprises an access control module (please see FIG. 7 at 706).

In another embodiment, the site access screen 1350 comprises the access instructions 1352 and, optionally, the preview 1354. Referring also to FIG. 7, the application may be configured to recognize the access control module 706 of the loading site 770. For example, if the access control module 706 utilizes a Bluetooth interface, the application may be able to initiate a secure pairing request with the access control module 706. Or, if the access control module 706 utilizes a Wi-Fi™ interface, the application may be able to securely connect to the access control module 706.

In other words, the application may be configured to detect that the client device 720a is in adequate proximity to the access control module 706 such that the wireless interfaces of the client device 720a and the access control module 706 may communicatively couple. Upon establishing this connection, the application may be configured to forward the key 703 to the access control module 706, causing the lock of the access control module 706 to be unlocked. Then, the driver may gain access to the loading site 770 and resume load delivery.

### Notifications and Reporting

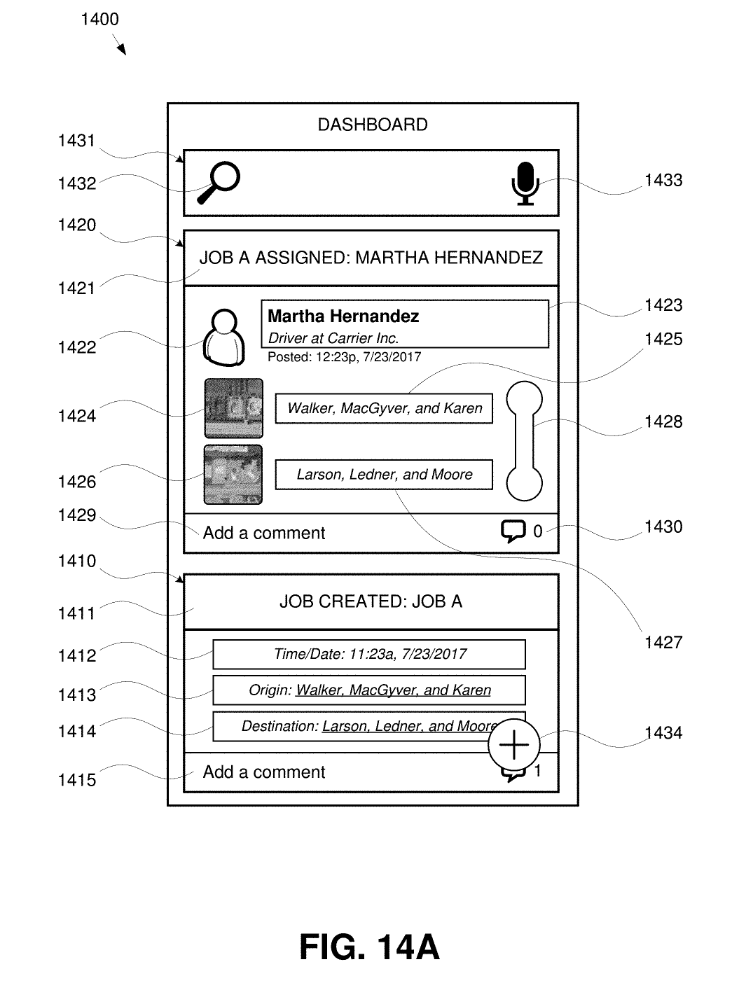

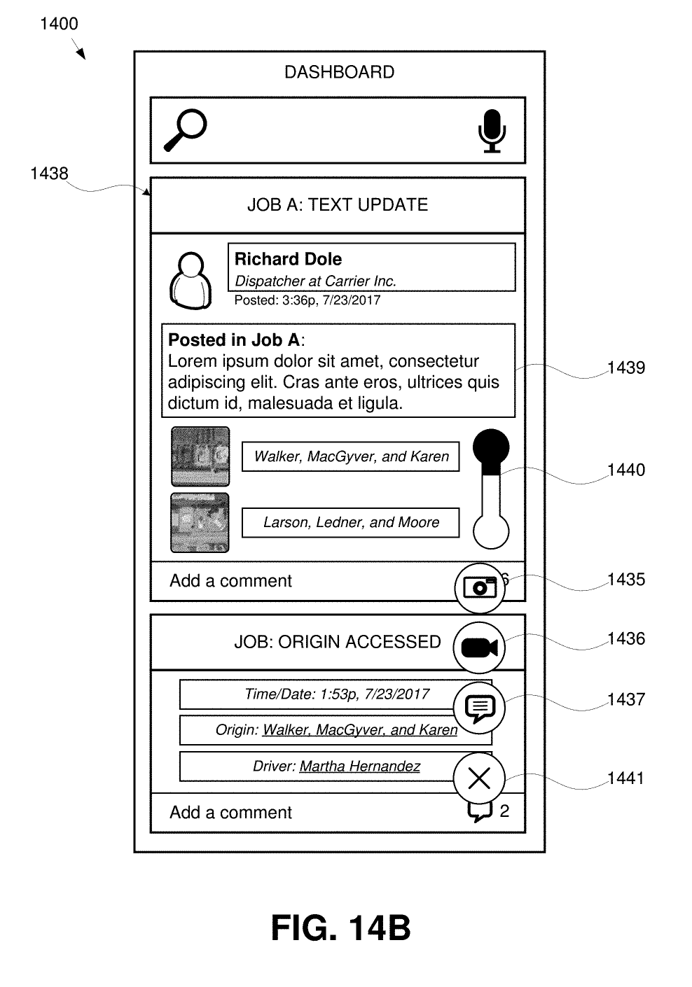

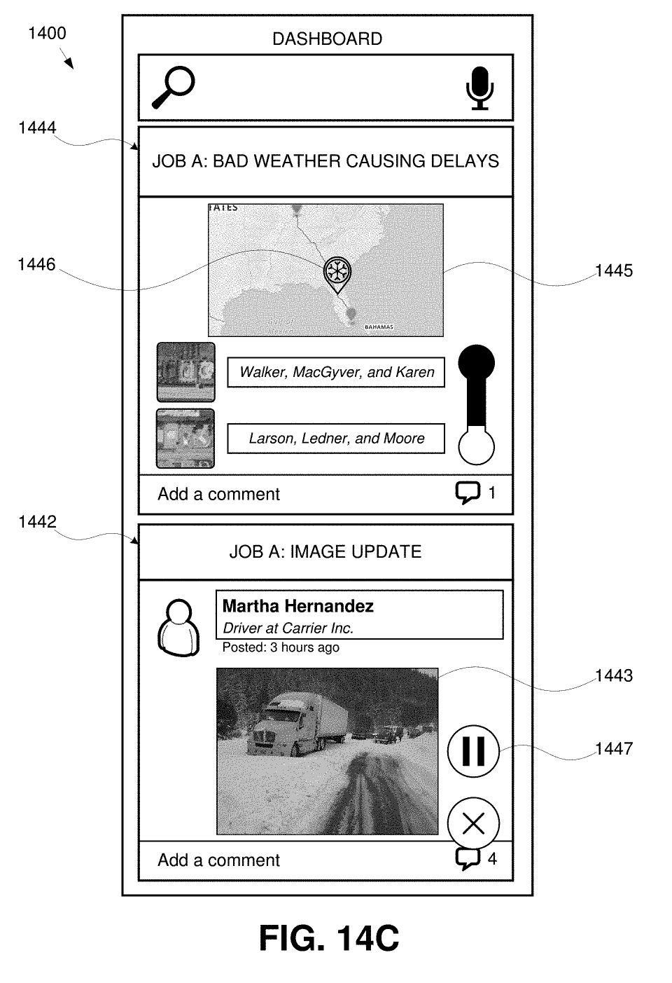

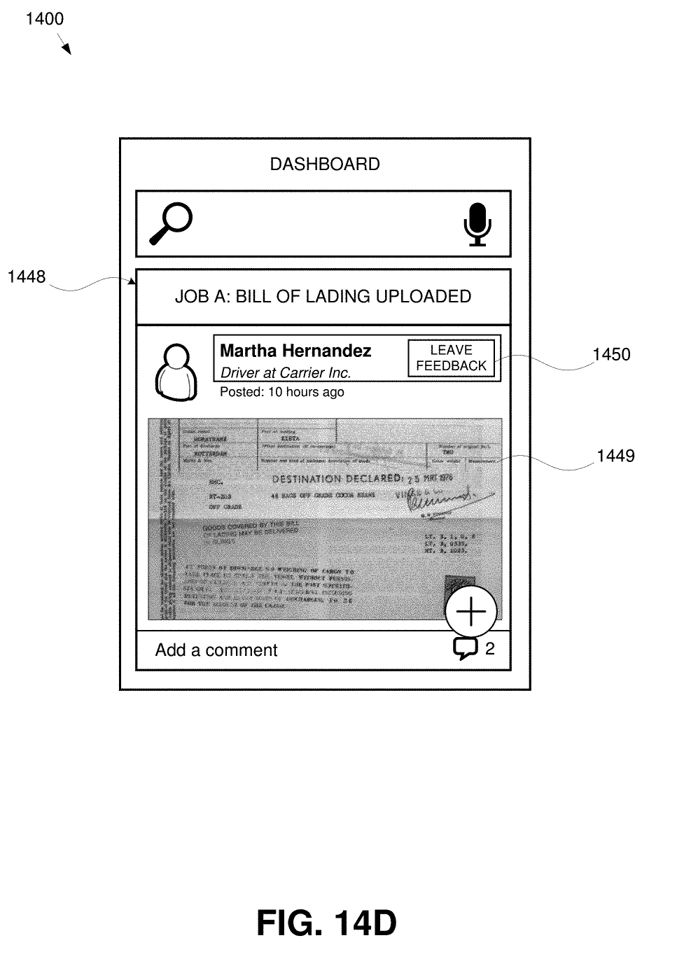

Referring to FIG. 14A, an exemplary dashboard 1400 illustrating job assignment and job creation notifications is shown. Generally, the dashboard 1400 allows a user to view job updates and details thereof on one or more cards stacked in reverse chronological order and comprising status event details. The dashboard 1400 may be accessed by, for example, selecting the “Dashboard” option 1008 on the navigation screen 1000 (see FIG. 10).

As shown in FIG. 14A, the dashboard may comprise one or more notifications that may be displayed when a status event occurs.

In one embodiment, when a job is created, (i.e., through the job creation process 800 as illustrated in FIG. 8A) a notification card 1410 may appear on the dashboard 1400 of all stakeholders associated with Job A. The notification card 1410 may comprise a title header 1411, and job information such as: the time/date 1412 the job is requested, (i.e., for a load delivery, the pick-up time) the origin site 1413, and the destination site 1414. The notification card 1411 may also provide a facility to ‘Add a Comment’ 1415, allowing stakeholders to hold conversations associated with the notification card 1411.

In another embodiment, when a job is assigned, a notification card 1420 may appear on the dashboard 1400 of all stakeholders associated with Job A, as shown in FIG. 14A. The notification card 1420 may comprise a title header 1421 and assignee information, such as: a photo 1422 of the assignee and a description 1423 of the assignee including the assignee's name, the assignee's affiliated company, and the assignee's position at that company. Additionally, the notification card 1420 may also comprise a photo 1424 and a description 1425 of the origin site and a photo 1426 and a description 1427 of the destination site. The notification card 1421 may also provide a facility to ‘Add a Comment’ 1429 or view past comments 1430. A progress bar 1428 may also be shown, illustrating how far the load delivery has progressed. As shown in FIG. 14A, recently assigned Job A shows no progress, and so the progress bar 1428 may be empty.

In one embodiment, the progress bar 1428 may illustrate load delivery progress in discrete amounts, i.e., the progress bar 1428 fills up incrementally as status events occur. In another embodiment, the progress bar 1428 may show progress continuously based on data related to the load delivery. For example, the progress bar 1428 may be filled as a function of the amount of distance traveled divided by the distance of the entire route.

The dashboard 1400 may also provide a search bar 1431 allowing a stakeholder to use a text search 1432 to search through notification cards using keywords or use a voice search 1433 to utilize a speech-to-text module of the application.

The dashboard 1400 may also provide a facility for sending an update 1434 for a particular job. Referring to FIG. 14B, the dashboard 1400 is shown illustrating a facility to submit updates 1435-1437. Upon selecting the update 1434 button as shown in FIG. 14A, an image capture button 1435, a video capture button 1436, and a text update button 1437 may be displayed as an overlay over the dashboard 1400. At any time, the user may cancel sending an update by selecting the cancel button 1441.

To submit an image for a particular job and notify all stakeholders of said image, the user may select the image capture button 1435, which may prompt the user to select an image stored in the memory of the user's client device or capture an image through a camera of the client device.

To submit a video for a particular job and notify all stakeholders of said video, the user may select the video capture button 1437, which may prompt the user to select a video stored in the memory of the user's client device or capture a video through a video camera of the client device. The selected or captured video may be uploaded along with metadata associated the video with the job.

To submit a text update for a particular job and notify all stakeholders of said text update, the user may select the text update button 1437, which may prompt the user to input the content of the text. Once submitted, the text update may be shown as a notification card, such as notification card 1438, which may display the body 1439 of the text update.

The communications described above may allow, for example, a driver to capture a photo of damages, shortages, or returns. Or, the driver may be able to capture a photo of an emergency or dangerous situation (such as a snow bank obstacle or a vehicular accident). Or, a destination site owner may be able to communicate to the driver ahead of time changes to the destination site protocols. Or, a driver at a loading site after hours may be able to request access to the loading site, which loading site owner may provide the driver access by remotely unlocking an access control module of the loading site.

Referring to FIG. 14C, the dashboard 1400 is shown illustrating exemplary notification cards for adverse job conditions. For example, the driver assigned to Job A (i.e., Martha Hernandez of Carrier Inc.) may upload an image update through the application, causing a notification card 1442 to appear through the dashboard 1400 showing a captured image 1443.

In one embodiment, the application may detect adverse conditions (e.g., inclement weather, heavy traffic congestion, construction) and subsequently cause the load delivery process to enter an exception state during which further status events may not be entered unless the load delivery process exits the exception state. For example, the job creator, upon receiving notification of the notification cards 1442, may select an exception state button 1447 which may cause the a notification card 1444 to appear through the dashboard 1400.

As shown in FIG. 14C, the notification card 1444 may comprise a map 1445 showing the route of the load delivery and one or more adverse condition indicators 1446. For example, as shown in FIG. 14C, the adverse condition indicator 1446 may indicate on the map 1445 where the weather on the route may be icy and therefore dangerous, if not impossible, to traverse. Similar indicators may be used for different adverse conditions.

In another embodiment, the application may automatically detect adverse route conditions based on data from third-party systems, cause the load delivery to enter an exception state, and communicate the notification card 1444 to that effect through the dashboard 1400.

The adverse route conditions may be detected based on one or more parameters of the load delivery reaching a predetermined amount. For example, the platform may access a third-party system that may issue detailed, up-to-date weather data based on location and/or a third-party system that provides detailed, up-to-date traffic measurements. The application may be configured to detect, for example, whether the route of the load delivery will enter a region suffering from a storm, or whether traffic in a region has slowed to a crawl.

In another embodiment, the driver may select the exception state button 1447 to cause the load delivery to enter the exception state. Or, in another embodiment, the platform may determine, from a text update, image update (as in FIG. 14C at 1443), or video update, that adverse conditions are present and may cause the notification card 1444 to be displayed through the dashboard 1400.

Referring to FIG. 14D, the dashboard 1400 is shown illustrating an exemplary notification card for the final stages of a load delivery. Upon reaching a destination site and confirming delivery, the driver may complete the load delivery process through the application by uploading a signed Bill of Lading. Once uploaded, the dashboard 1400 may display a notification card 1448 to all stakeholders showing a preview 1449 of the Bill of Lading and a facility for a stakeholder to leave feedback 1450 for the driver.

In one embodiment, leaving feedback to the driver may involve providing a rating (e.g., 4 out of 5 stars) and an optional comment. However, further feedback may be gathered by prompting the stakeholder to answer one or more questions related to the stakeholder's overall experience with the driver, such as level of responsiveness, promptness of delivery, and/or quality of overall work.

### Optimization and Analysis

The platform provides automation tools and features that help increase velocity through a supply chain. These tools can help drivers to streamline their delivery, communicate effectively with other stakeholders, and load/unload during a site's off-hours; carriers to track loads in real-time and predict and eliminate inefficiencies; receivers/shippers to commission pick-up/accept deliveries during off-hours; dispatchers to more efficiently manage multiple active load deliveries by multiple drivers; and brokers to more quickly and effectively broker load deliveries between other stakeholders.

Most importantly, the platform leverages drivers as the functional units within the trucking supply chain due to their unique role as mobile data generators through their respective client devices. Drivers are currently unable to exploit the wealth of data that a supply chain powered by the platform can provide. Combined with increasingly restrictive emissions regulations and limited delivery windows, a driver's earning potential can be drastically reduced, and for these reasons, many drivers are forced to switch careers.

In one embodiment, a method involving analyzing a supply chain implemented on a client device comprises receiving status events and metrics associated with a load being delivered by a user of the client device. The method further comprises comparing the metrics associated with the load to historical data, wherein the historical data comprise metrics and past status events associated with one or more delivered load(s).

In a further embodiment, the comparison may be a statistical comparison between historical data and metrics associated with the load delivery to determine a likelihood of a status event for the load delivery. For example, historical ‘job acceptance’ status events for a particular ‘distance’ and/or ‘location’ similar to the active load may be used to determine a number and location of individual drivers that may be available to accept the load delivery. These drivers, for example, may constitute the drivers list as shown in FIG. 11B. This ultimately may influence further status events, such as the job creator assigning the job to a particular driver from the list.

In other words, the method involves determining actionable correlations between past and present metrics for a load to generate influencers that affect further status events for the load. These influencers may be recognized based on a predetermined threshold of statistical probability and may manifest as, for example, adaptations to user interface screens that create a dynamic user experience that changes according to present metrics.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

Embodiments of the subject matter and the functional operations described in this specification can be implemented in one or more of the following: digital electronic circuitry; tangibly-embodied computer software or firmware; computer hardware, including the structures disclosed in this specification and their structural equivalents; and combinations thereof. Such embodiments can be implemented as one or more modules of computer program instructions encoded on a tangible non-transitory program carrier for execution by, or to control the operation of, data processing apparatus (i.e., one or more computer programs). Program instructions may be, alternatively or additionally, encoded on an artificially generated propagated signal (e.g., a machine-generated electrical, optical, or electromagnetic signal) that is generated to encode information for transmission to suitable receiver apparatus for execution by a data processing apparatus. And the computer storage medium can be one or more of: a machine-readable storage device, a machine-readable storage substrate, a random or serial access memory device, and combinations thereof.

As used herein, the term “data processing apparatus” or “client device” comprises all kinds of apparatuses, devices, and machines for processing data, including but not limited to, a programmable processor, a computer, and/or multiple processors or computers. Exemplary apparatuses may include special purpose logic circuitry, such as a field programmable gate array (“FPGA”) and/or an application specific integrated circuit (“ASIC”). In addition to hardware, exemplary apparatuses may comprise code that creates an execution environment for the computer program (e.g., code that constitutes one or more of: processor firmware, a protocol stack, a database management system, an operating system, and a combination thereof).

The term “computer program” may also be referred to or described herein as a “program,” “software,” a “software application,” a “module,” a “software module,” a “script,” or simply as “code.” A computer program may be written in any form of programming language, including compiled or interpreted languages, or declarative or procedural languages, and it can be deployed in any form, including as a standalone program or as a module, component, subroutine, or other unit suitable for use in a computing environment. Such software may correspond to a file in a file system. A program can be stored in a portion of a file that holds other programs or data. For example, a program may include one or more scripts stored in a markup language document; in a single file dedicated to the program in question; or in multiple coordinated files (e.g., files that store one or more modules, sub programs, or portions of code). A computer program can be deployed and/or executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as but not limited to an FPGA and/or an ASIC.

Computers suitable for the execution of the one or more computer programs include, but are not limited to, general purpose microprocessors, special purpose microprocessors, and/or any other kind of central processing unit (“CPU”). Generally, CPU will receive instructions and data from a read only memory (“ROM”) and/or a random access memory (“RAM”). The essential elements of a computer are a CPU for performing or executing instructions and one or more memory devices for storing instructions and data. Generally, a computer will also include, or be operatively coupled to receive data from or transfer data to, or both, one or more mass storage devices for storing data (e.g., magnetic, magneto optical disks, and/or optical disks). However, a computer need not have such devices. Moreover, a computer may be embedded in another device, such as but not limited to, a mobile telephone, a personal digital assistant (“PDA”), a mobile audio or video player, a game console, a Global Positioning System (“GPS”) receiver, or a portable storage device (e.g., a universal serial bus (“USB”) flash drive).

Computer readable media suitable for storing computer program instructions and data include all forms of nonvolatile memory, media and memory devices. For example, computer readable media may include one or more of the following: semiconductor memory devices, such as erasable programmable read-only memory (“EPROM”), electrically erasable programmable read-only memory (“EEPROM”) and/or and flash memory devices; magnetic disks, such as internal hard disks or removable disks; magneto optical disks; and/or CD ROM and DVD-ROM disks. The processor and the memory can be supplemented by, or incorporated in, special purpose logic circuitry.

To provide for interaction with a user, embodiments may be implemented on a computer having any type of display device for displaying information to a user. Exemplary display devices include, but are not limited to one or more of: projectors, cathode ray tube (“CRT”) monitors, liquid crystal displays (“LCD”), light-emitting diode (“LED”) monitors and/or organic light-emitting diode (“OLED”) monitors. The computer may further comprise one or more input devices by which the user can provide input to the computer. Input devices may comprise one or more of: keyboards, a pointing device (e.g., a mouse or a trackball). Input from the user can be received in any form, including acoustic, speech, or tactile input. Moreover, feedback may be provided to the user via any form of sensory feedback (e.g., visual feedback, auditory feedback, or tactile feedback). A computer can interact with a user by sending documents to and receiving documents from a device that is used by the user (e.g., by sending web pages to a web browser on a user's client device in response to requests received from the web browser).

Embodiments of the subject matter described in this specification can be implemented in a computing system that includes one or more of the following components: a backend component (e.g., a data server); a middleware component (e.g., an application server); a frontend component (e.g., a client computer having a graphical user interface (“GUI”) and/or a web browser through which a user can interact with an implementation of the subject matter described in this specification); and/or combinations thereof. The components of the system can be interconnected by any form or medium of digital data communication, such as but not limited to, a communication network. Non-limiting examples of communication networks include a local area network (“LAN”) and a wide area network (“WAN”), e.g., the Internet.

The computing system may include clients and/or servers. The client and server may be remote from each other and interact through a communication network. The relationship of client and server arises by virtue of computer programs running on the respective computers and having a client-server relationship to each other.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

What is claimed is:

1. A computer program product encoded on one or more non-transitory computer storage media, the computer program product comprising instructions that when executed by one or more computers cause the one or more computers to perform operations comprising:
receiving load details from a job creator relating to a load to be delivered from a shipper to a receiver by a driver,
wherein the shipper is associated with an origin site,
wherein the receiver is associated with a destination site;
receiving origin site details and destination site details;
receiving a pickup confirmation from the driver;
receiving a drop-off confirmation from the driver; and
receiving a signed bill of lading document from the driver.
